(19) United States
(12) Patent Application Publication
(10) Pub. No.: US 2019/0319462 A1
(43) Pub. Date: Oct. 17, 2019

(54) Stackable Sound Lamp Assembly

(71) Applicant: Dong Guan Bright Yinhuey Lighting Co., ltd., Guang Dong (CN)

(72) Inventor: Kevin Hsu, Taichung (TW)

(21) Appl. No.: 15/950,266

(22) Filed: Apr. 11, 2018

(51) Int. Cl. H02J 7/00; F21V 33/00; F21V 23/02; F21V 23/06; F21V 21/005; F21S 9/02; H04R 1/02

(52) U.S. Cl. CPC H02J 7/0013; F21V 33/0056; F21V 23/02; H04R 1/028; F21V 21/005; F21S 9/02; H02J 7/0045; F21V 23/06

(57) ABSTRACT

A stackable sound lamp assembly includes a charging seat, a sound lamp and a plurality of movable lamps. The movable lamps are stacked mutually, and are placed on and charged by the charging seat. The sound lamp charges one of the movable lamps or the movable lamps that are stacked. The sound lamp is provided with a contact. Each of the movable lamps includes a first lighting device, a first battery and a first housing. The first lighting device is electrically connected with the first battery. The first housing has a top provided with a contact which is electrically connected with the first battery. The first housing has a bottom provided with a spring pin which is electrically connected with the first battery and is used for charging.

### BACKGROUND OF THE INVENTION

### 1. Field of the Invention

The present invention relates to a sound lamp and, more particularly, to a stackable sound lamp assembly.

### 2. Description of the Related Art

A lighting system is combined with a music playing system to construct a sound lamp which contains illuminating and amusement functions simultaneously, so as to relax and provide a comfortable sensation to the user. However, when multiple sound lamps mate and cooperate with each other, the sound lamps are charged independently and cannot be charged simultaneously, thereby decreasing the charging efficiency.

### BRIEF SUMMARY OF THE INVENTION

The primary objective of the present invention is to provide a stackable sound lamp assembly that provides illuminating and audio playing functions.

In accordance with the present invention, there is provided a stackable sound lamp assembly comprising a charging seat, a sound lamp and a plurality of movable lamps. The movable lamps are stacked mutually. The movable lamps that are stacked are placed on and charged by the charging seat. One of the movable lamps is placed on and charged by the charging seat. The sound lamp charges one of the movable lamps or the movable lamps that are stacked. The sound lamp is provided with a contact. Each of the movable lamps includes a first lighting device, a first battery and a first housing. The first lighting device and the first battery are mounted on the first housing. The first lighting device is electrically connected with the first battery which provides an electric power to the first lighting device. The first housing has a top provided with a contact which is electrically connected with the first battery. The first housing has a bottom provided with a spring pin which is electrically connected with the first battery. The spring pin is used for charging.

Preferably, the sound lamp includes an audio module, a second lighting device, a second battery and a second housing. The audio module, the second lighting device and the second battery are mounted on the second housing. The audio module and the second lighting device are electrically connected with the second battery which provides an electric power to the audio module and the second lighting device. The contact of the sound lamp is mounted on a top of the second housing.

Preferably, the sound lamp further includes a charging port. An external power supply charges the second battery through the charging port.

According to the primary advantage of the present invention, the sound lamp is provided with the contact, each of the movable lamps is provided with the contact and the spring pin, and the movable lamps are stacked mutually.

According to another advantage of the present invention, the sound lamp or the charging seat charges one of the movable lamps quickly.

According to a further advantage of the present invention, the sound lamp or the charging seat simultaneously charges the movable lamps that are stacked mutually.

Further benefits and advantages of the present invention will become apparent after a careful reading of the detailed description with appropriate reference to the accompanying drawings.

### BRIEF DESCRIPTION OF THE SEVERAL VIEWS OF THE DRAWING(S)

FIG. 1 is a front view of a sound lamp of a stackable sound lamp assembly in accordance with the preferred embodiment of the present invention.

FIG. 2 is a top view of the sound lamp of the stackable sound lamp assembly as shown in FIG. 1.

FIG. 3 is a front view of a movable lamp of the stackable sound lamp assembly in accordance with the preferred embodiment of the present invention.

FIG. 4 is a top view of the movable lamp of the stackable sound lamp assembly as shown in FIG. 3.

FIG. 5 is a bottom view of the movable lamp of the stackable sound lamp assembly as shown in FIG. 3.

FIG. 6 is a front view of a charging seat of the stackable sound lamp assembly in accordance with the preferred embodiment of the present invention.

FIG. 7 is a top view of the charging seat of the stackable sound lamp assembly as shown in FIG. 6.

FIG. 8 is a front view showing that the movable lamps are stacked and charged by the sound lamp.

FIG. 9 is a front view showing that the movable lamps are stacked and charged by the charging seat.

### DETAILED DESCRIPTION OF THE INVENTION

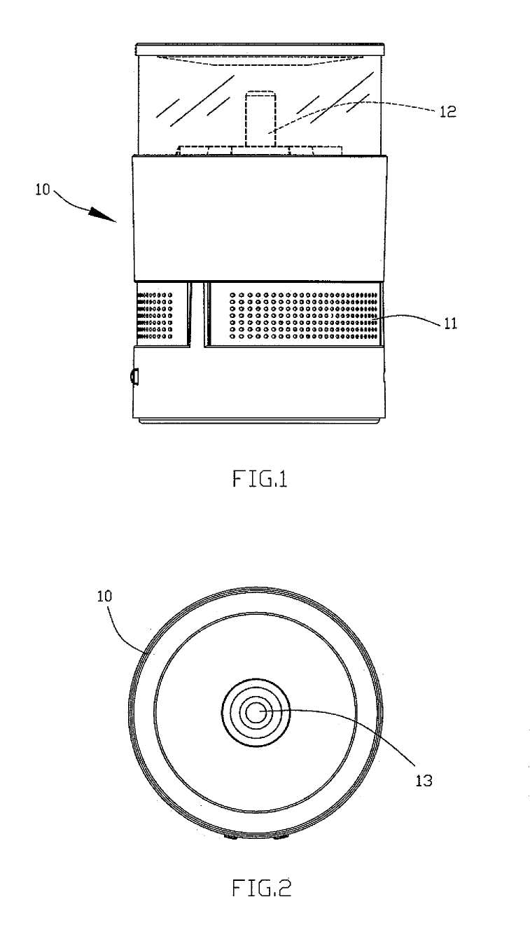

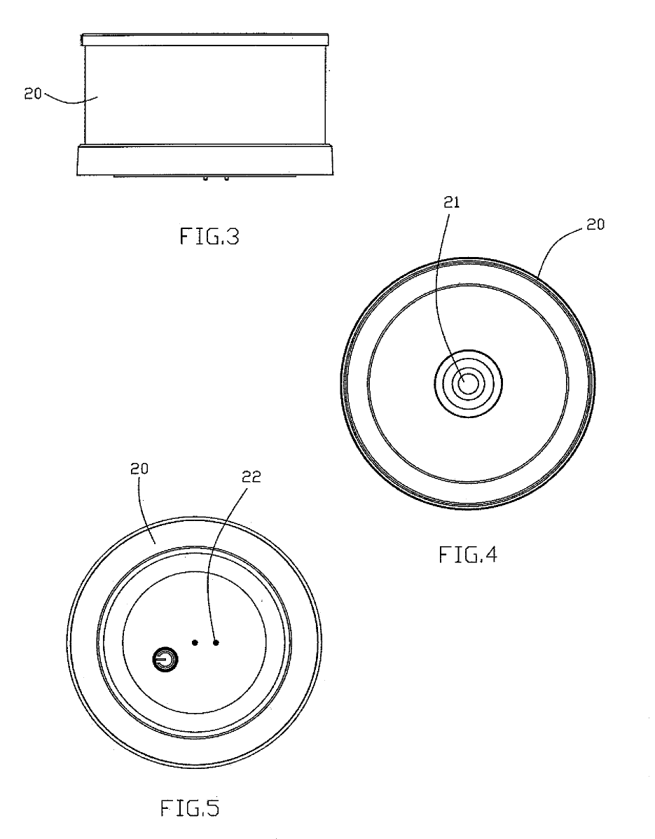

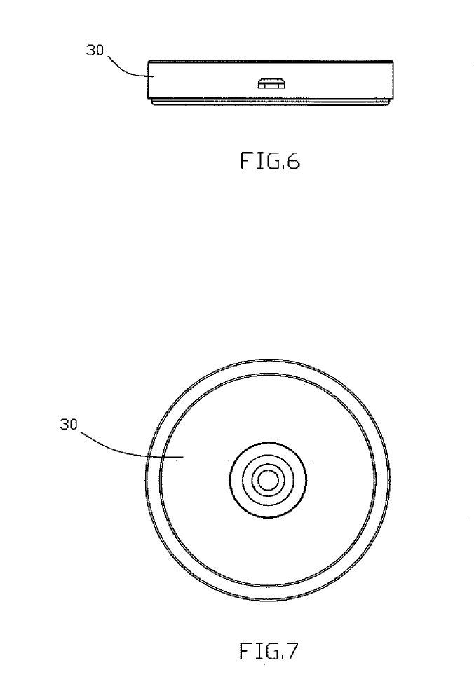

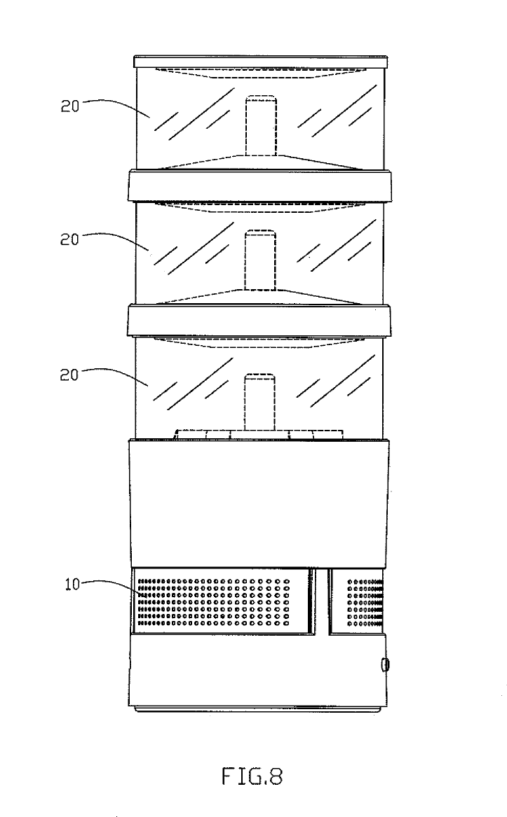

Referring to the drawings and initially to FIGS. 1-7, a stackable sound lamp assembly in accordance with the preferred embodiment of the present invention comprises a charging seat 30, a sound lamp 10 and a plurality of movable lamps 20.

The movable lamps 20 are stacked mutually and are electrically connected with each other. The movable lamps 20 that are stacked are placed on and charged by the charging seat 30. One of the movable lamps 20 is placed on and charged by the charging seat 30. The sound lamp 10 charges one of the movable lamps 20 or the movable lamps 20 that are stacked. The sound lamp 10 is provided with a contact 13. Each of the movable lamps 20 includes a first lighting device, a first battery and a first housing. The first lighting device and the first battery are mounted on the first housing. The first lighting device is electrically connected with the first battery which provides an electric power to the first lighting device. The first housing has a top provided with a contact 21 which is electrically connected with the first battery through an electric wire. The first housing has a bottom provided with a spring pin 22 which is electrically connected with the first battery. The spring pin 22 is used for charging.

In the preferred embodiment of the present invention, the sound lamp 10 includes an audio module 11, a second lighting device 12, a second battery and a second housing. The audio module 11, the second lighting device 12 and the second battery are mounted on the second housing. The audio module 11 and the second lighting device 12 are electrically connected with the second battery which provides an electric power to the audio module 11 and the second lighting device 12. The contact 13 of the sound lamp 10 is mounted on a top of the second housing and is electrically connected with the second battery through an electric wire.

In the preferred embodiment of the present invention, the sound lamp 10 further includes a charging port. An external power supply charges the second battery through the charging port.

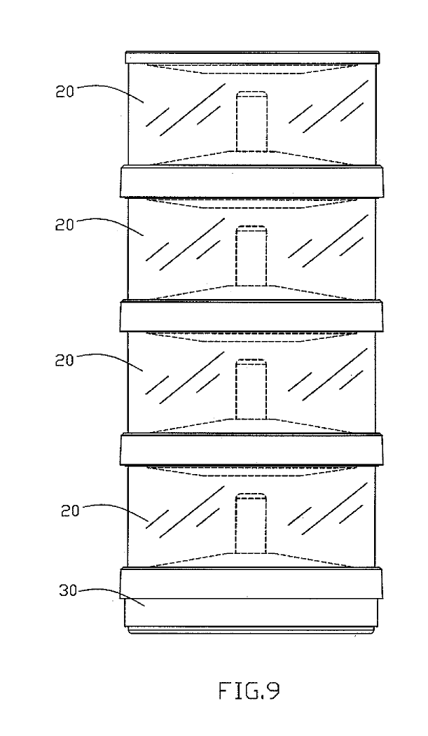

In operation, referring to FIGS. 8 and 9 with reference to FIGS. 1-7, when the movable lamps 20 are stacked mutually, the contact 21 of one of the movable lamps 20 touches the spring pin 22 of another of the movable lamps 20, so that the movable lamps 20 are conducted electrically. In such a manner, the user charges one or multiple of the movable lamps 20 according to the practical requirement.

When the user wishes to charge one of the movable lamps 20, the one of the movable lamps 20 is placed on the sound lamp 10 or the charging seat 30, so that the spring pin 22 of the one of the movable lamps 20 touches the contact 13 of the sound lamp 10 or the charging seat 30. Thus, the external power supply charges the one of the movable lamps 20 through the sound lamp 10 or the charging seat 30.

When the user wishes to charge the movable lamps 20, the movable lamps 20 are stacked mutually. Then, the movable lamps 20 that are stacked are placed on the sound lamp 10 as shown in FIG. 8 or placed on the charging seat 30 as shown in FIG. 9, so that the spring pin 22 of the lowermost one of the movable lamps 20 touches the contact 13 of the sound lamp 10 or the charging seat 30. Thus, the external power supply charges the movable lamps 20 through the sound lamp 10 or the charging seat 30.

Accordingly, the sound lamp 10 is provided with the contact 13, each of the movable lamps 20 is provided with the contact 21 and the spring pin 22, and the movable lamps 20 are stacked mutually. In addition, the sound lamp 10 or the charging seat 30 charges one of the movable lamps 20 quickly. Further, the sound lamp 10 or the charging seat 30 simultaneously charges the movable lamps 20 that are stacked mutually.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the scope of the invention.

1. A stackable sound lamp assembly comprising:
a charging seat, a sound lamp and a plurality of movable lamps;
wherein:
the plurality of movable lamps comprise one non-stacked movable lamp and a plurality of movable lamps that are stacked interchangeably;
the charging seat is configured to directly charge and seat the one non-stacked movable lamp and the plurality of movable lamps that are stacked interchangeably;
the sound lamp is configured to directly charge and seat the one non-stacked movable lamp and the plurality of movable lamps that are stacked interchangeably;
the sound lamp is provided with a contact;
each of the movable lamps includes a first lighting device, a first battery and a first housing;
the first lighting device is electrically connected with the first battery which provides an electric power to the first lighting device;
the first housing has a top provided with a contact which is electrically connected with the first battery;
the first housing has a bottom provided with a spring pin which is electrically connected with the first battery; and
the spring pin is used for charging.

2. The stackable sound lamp assembly of claim 1, wherein:
the sound lamp includes an audio module, a second lighting device, a second battery and a second housing;
the audio module and the second lighting device are electrically connected with the second battery which provides an electric power to the audio module and the second lighting device; and
the contact of the sound lamp is mounted on a top of the second housing.

3. The stackable sound lamp assembly of claim 2, wherein:
the sound lamp further includes a charging port; and
an external power supply charges the second battery through the charging port.

4. The stackable sound lamp assembly of claim 1, wherein the charging seat or the sound lamp is configured to directly charge the first battery of the one non-stacked movable lamp and the plurality of movable lamps that are stacked interchangeably.
